(19) United States
(12) Patent Application Publication
(10) Pub. No.: US 2013/0072051 A1
(43) Pub. Date: Mar. 21, 2013

(54) KIT OF PARTS, CONTACTING ELEMENT AND LUMINAIRE

(71) Applicants: Johannes Wilhelmus Weekamp, Beek En Donk (NL); Cornelis Gerardus Visser, Eindhoven (NL)

(72) Inventors: Johannes Wilhelmus Weekamp, Beek En Donk (NL); Cornelis Gerardus Visser, Eindhoven (NL)

(73) Assignee: KONINKLIJKE PHILIPS ELECTRONICS N.V., EINDHOVEN (NL)

(21) Appl. No.: 13/700,593

(22) PCT Filed: May 30, 2011
(86) PCT No.: PCT/IB11/52354

§ 371 Date: Nov. 28, 2012

(30) Foreign Application Priority Data
Jun. 1, 2010 (EP) 10164584.4

(51) Int. Cl. H01R 4/24

(52) U.S. Cl. CPC H01R 4/24
USPC 439/391

(57) ABSTRACT

Kit of parts comprising an insulated electric cable comprising at least two, mutually separated electrically conducting wires embedded in an annular layer of electrically insulating material. The kit of parts further comprises an electric contacting element having a piercing part. Said piercing part penetrating the insulated electric cable and contacting one of the conducting wires. The at least one electric contacting element is made of pliant material and is wrapped around the cable. The cable has an outer surface formed by the insulating material, and for each electrically conducting wire a respective wire location indication is provided at said outer surface at a position where the respective conducting wire is closest to the outer surface.

### FIELD OF THE INVENTION

The invention relates to a kit of parts comprising an insulated electric cable comprising an electrically conducting wire embedded in an annular layer of electrically insulating material, and at least one electric contacting element comprising at least one piercing part, said piercing part penetrating the insulated electric cable and contacting the conducting wire. The invention further relates to a contacting element and a luminaire having electrical connectors matching in shape with the contacting element.

### BACKGROUND OF THE INVENTION

Such a kit of parts is known from U.S. Pat. No. 6,206,720. The known kit of parts comprises two contacting elements, each of said contacting elements comprising a fork-shaped piercing part for contacting a respective conducting wire. Both said contacting elements form an insulation displacement connector module (IDC) and are fixed in a polymer. It is a disadvantage that for the contacting elements to be fixed in the polymer, not only the polymer but also the contacting elements have a relatively complex and bulky shape. Furthermore, the known contacting element has the disadvantage of being of a relatively complex construction for enabling it to be fixed onto the cable, requiring a number of separate parts including screws as securing means having the disadvantage of a relatively laborious and cumbersome mounting of the contacting element on the cable.

### SUMMARY OF THE INVENTION

It is an object of the invention to provide a kit of parts of the type as described in the opening paragraph, in which at least one of the above-mentioned disadvantages is counteracted. To achieve this, the kit of parts according to the invention is characterized in that the at least one electric contacting element is made of pliant material and is wrapped around the cable. The piercing part can be embodied for example as a fork, a blade, a pin, or a screw. As a result of the piercing activity of the piercing part and the contacting element being wrapped around the cable, the contacting element forms an IDC that is fixed on the cable. Fixation of the contacting element on the cable is thus simplified, as the number of parts to be assembled is reduced, in that parts otherwise required to mount the contacting element onto the cable, for example separate fixation means, such as screws, are disposed of. Furthermore, there is no need to slide the contacting element over the cable to the right location, as the contacting element is wrapped around the cable at the right location.

An embodiment of the kit of parts is characterized in that the cable comprises at least two, mutually separated electrically conducting wires which are eccentrically located, i.e. off-axis, in the cable. It is thus possible to connect each conducting wire with a respective contacting element, without the need for the piercing part to penetrate relatively deep into the cable as, due to the eccentric location of the conducting wires, said conducting wires are relatively close to certain parts of the outer surface of the cable.

An embodiment of the kit of parts is characterized in that the cable has an outer surface formed by the insulating material and that for each electrically conducting wire a respective wire location indication is provided at said outer surface at a position where the respective conducting wire is closest to the outer surface and in a length direction of the cable along the respective electrically conducting wire. It is thus made possible to connect each conducting wire with a respective contacting element in a relatively simple manner and with a reduced risk of accidentally contacting more than one conducting wire.

An embodiment of the kit of parts is characterized in that the respective wire location indication is chosen from the group consisting of a relief in the outer surface, an imprint on the outer surface, local bulk-colored insulating covering material at the outer surface. The relief could be an indent in the outer surface, or a protrusion of the outer surface, enabling those who have only limited sight, for example when one is working in a poorly illuminated environment, to easily locate the conducting wire by sensing with fingers. An imprint is a relatively cheap way of providing an indication, but involves some risk in that it can be wiped off, which risk is counteracted when using local bulk-colored insulating covering material at the outer surface.

An embodiment of the kit of parts is characterized in that the contacting element has a form that has assumed the shape of the circumference of the cross section of the cable transverse to the length of the cable. The contacting element then has about the same contour as the cross section of the cable and thus does not protrude, or protrudes only over a relatively small distance, from the cable, enabling relatively tight fitting objects for positioning to be slid over the cable length without too much difficulty. This is further improved when the outer surfaces of the cable and the contacting element are practically flush with each other.

An embodiment of the kit of parts is characterized in that the contacting element is one integral, metal part. Simple manufacturing of the contacting element by cutting from flat metal plate, using a die is thus enabled. In subsequent folding steps, one of these steps being wrapping the contacting element around the cable, the contacting element is given its desired, final shape.

An embodiment of the kit of parts is characterized in that the contacting element is provided with a corrosion and/or oxidation resistant coating or is made from corrosion and/or oxidation resistant material. Alternatively, a protective gel could be provided to counteract corrosion. Environmental circumstances often cause the electrical contact between contacting element and conducting wire to decrease for example due to arcing, corrosion, and oxidation. By providing a corrosion/oxidation resistant contacting element, a relatively reliable electrical contact between contacting element and conducting wire is ensured throughout the lifetime.

An embodiment of the kit of parts is characterized in that the contact element has a round ring as the basic form onto which the at least one piercing part is mounted so as to extend radially inwards. The piercing part thus extends transversely to the length direction of the cable and only has to penetrate the round cable over a relatively short distance compared to the distance of penetration when the contacting element extends at an acute angle with respect to the length direction of the cable. To ensure that the contacting element reaches and contacts the centrally located conducting wire or an eccentrically located conducting wire, the piercing part has a piercing length in the range of 1/18th to 5/18th of the circumference of the round ring. Preferably, the piercing part has a piercing length in the range of 1/9th to ⅙th of the circumference of the round ring. Thus, it is further ensured on the one hand that if the cable has only one centrally provided conducting wire, said wire is reached and contacted, and on the other hand that if the cable has two, mutually separated, eccentrically located electrically conducting wires, the contacting element reaches and contacts only one of said wires.

An embodiment of the kit of parts is characterized in that the piercing part comprises a fork-shaped extension with a V-shaped notch with mutually facing cutting knife edges. By virtue of such a construction of the piercing part, the electrically conducting wire is embraced in a secure manner, and thus electrical contact is reliably maintained.

An embodiment of the kit of parts is characterized in that the cable is provided with at least one longitudinal strength member extending along the electrically conducting wires. Thus, a reinforced cable is formed comprising said strength member as a reinforcing core. Typically said strength member is made of steel or high strength fibers such as Kevlar or Dyneema. By using reinforced cables, the cable itself can be used both for suspension of luminaires and for providing electrical power to the luminaires. When at least two, eccentrically positioned, i.e. positioned off-axis, strength members are provided in the cable, the cable will always take an orientation such that the pull force in the strength members is lowest. By adjusting the tensile forces asserted on the strength members of the cable together with the influence of gravity, the mutual position of the strength members is controllable and thus the orientation of the cable is controllable. Consequently, as regards luminaires mounted onto the cable, both the orientation of the luminaires and their beam direction is controllable.

The invention further relates to a contacting element comprising all the characteristics of the contacting element as described in any one of the above-mentioned embodiments of the kit of parts.

The invention further relates to a luminaire having electrical connectors; at least two of said electrical connectors have a shape matching that of a respective contacting element of the kit of parts as described in any one of the abovementioned embodiments of the kit of parts. For its operation, a luminaire should have at least two electrical contacts, i.e. for connecting to a live wire and a neutral wire. By mounting at least two contacting elements at a mutual distance from each other, i.e. such that there is basically no electrical contact (short circuiting) between said contacting elements, the contacting elements being each connected to a respective, mutually different, electrically conducting wire, it is made possible to connect these to an electrical apparatus for providing electrical power to said apparatus, for example a luminaire, a light source or a transformer. The shape of the electrical connectors in the luminaire is adapted to the shape of the contacting elements as mounted onto the cable and preferably the shape of the luminaire is adapted so as to fit around the cable to make the luminaire less prone to aerodynamic influences, thus rendering the luminaire suitable for outdoor application. Preferably, the luminaire is mounted on the cable such that the electrical connections are shielded in a watertight manner from the environment; to this end, the luminaire is possibly accommodated in a separate housing.

### BRIEF DESCRIPTION OF THE DRAWING

The invention will now be further elucidated by means of the schematic drawing in which,

FIG. 1A shows a first embodiment of a kit of parts;

FIG. 1B shows a second embodiment of a cable of the kit of parts;

FIG. 2A shows an embodiment of a contacting element in unwrapped and folded state;

FIG. 2B shows an embodiment of the kit of parts with two contacting elements wrapped around a cable;

FIG. 3A shows a bottom view of a kit of parts before and after a luminaire is mounted on the kit of parts;

FIG. 3B shows a top view of the mounted luminaire of FIG. 3A;

FIG. 3C shows a bottom view photograph of a luminaire to be mounted on the kit of parts.

### DETAILED DESCRIPTION OF THE EMBODIMENTS

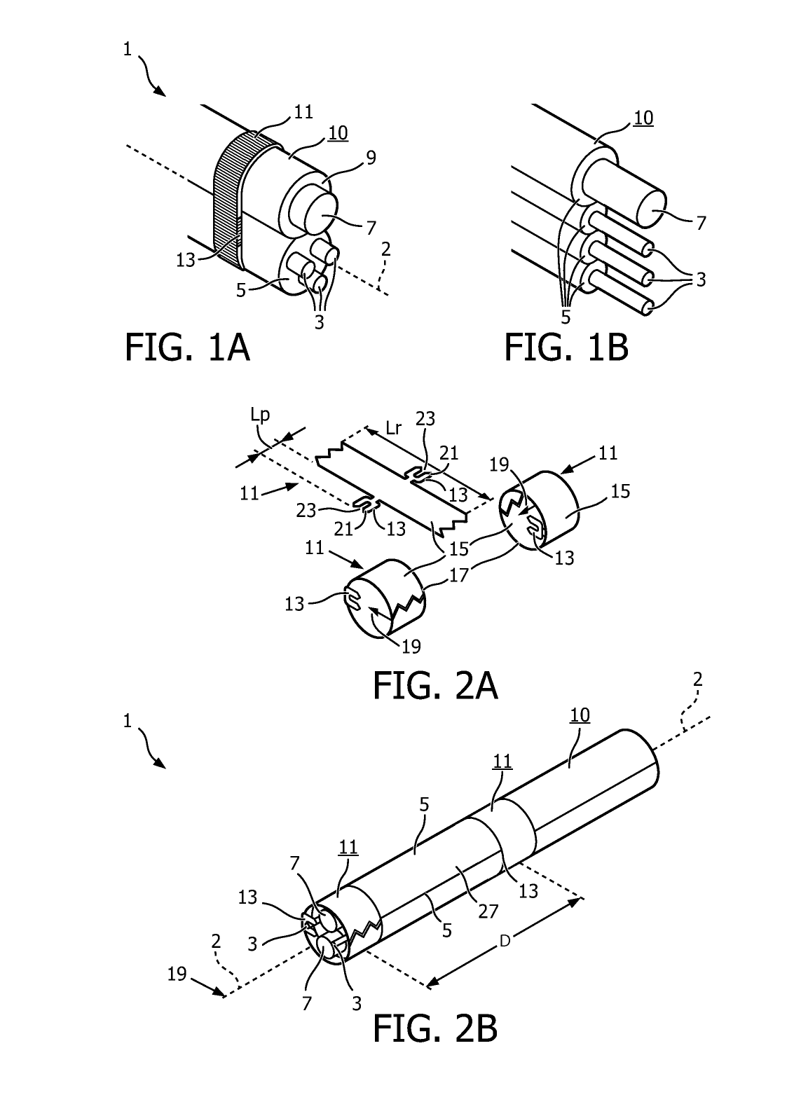

In FIG. 1A, a kit of parts 1 with an insulated electric cable 10 defining a length direction 2 comprises three, mutually separated electrically conducting wires 3 which are eccentrically embedded in an annular layer 5 of electrically insulating material and one strength member 7, in the Figure a metal strand, embedded in a polymer material 9. The annular layer and the polymer material are attached to each other to form one cable. One electric contacting element 11 is shown that comprises one piercing part 13, said piercing part penetrating the insulated electric cable and contacting only one of the conducting wires. The at least one electric contacting element is made of metal and is wrapped around the cable. FIG. 1B shows another configuration of a cable 10 with three conducting wires 3 and one strength member 7 embedded in electrically insulating material 5.

FIG. 2A shows an embodiment of a contacting element 11 in unwrapped and folded state. The contact element is one integral, metal part and is provided completely with a coating 15 that is resistant to corrosion/oxidation. In the folded state, the contact element has a round ring 17 as a basic form onto which the at least one piercing part 13 is mounted so as to extend inwards in a radial direction 19. The piercing part comprises a fork-shaped extension 21 with a V-shaped notch 23 with mutually facing cutting knife edges. The piercing part has a piercing length Lp of about ⅛th of the circumference Lr of the round ring.

FIG. 2B shows an embodiment of the kit of parts 1 with two contacting elements 11 wrapped around a round cable 10. The cable 10 comprises two, eccentrically positioned conducting wires 3 and two eccentrically positioned strength members 7, which are made, in the Fig., of poly-aramide fiber, for example Kevlar. Both the conducting wires and the strength members extend parallel to each other along a length direction 2, which could be considered as an axis, of the cable. In the cable, a respective wire location indication 25 is provided (only one is visible) at an outer surface 27 of the cable; in the Fig., the wire location indication is a groove in the length direction. Both contacting elements 11 are wrapped around the round cable and have assumed the shape of the cross-sectional outer contour of the cable, i.e. the contacting elements are ring-shaped. Each contacting element contacts with a piercing part 13 a respective one of the conducting wires 3 (only shown for one contacting element). The contacting element extends in an inward direction 19, transverse to the length direction 2 of the cable, and embraces the conducting wire with its fork-shaped extension. The contacting elements are mounted at a mutual distance D on the cable, said distance D being chosen such that it matches with the distance between electrical connectors of an electrical apparatus, for example a luminaire, to be mounted on the cable.

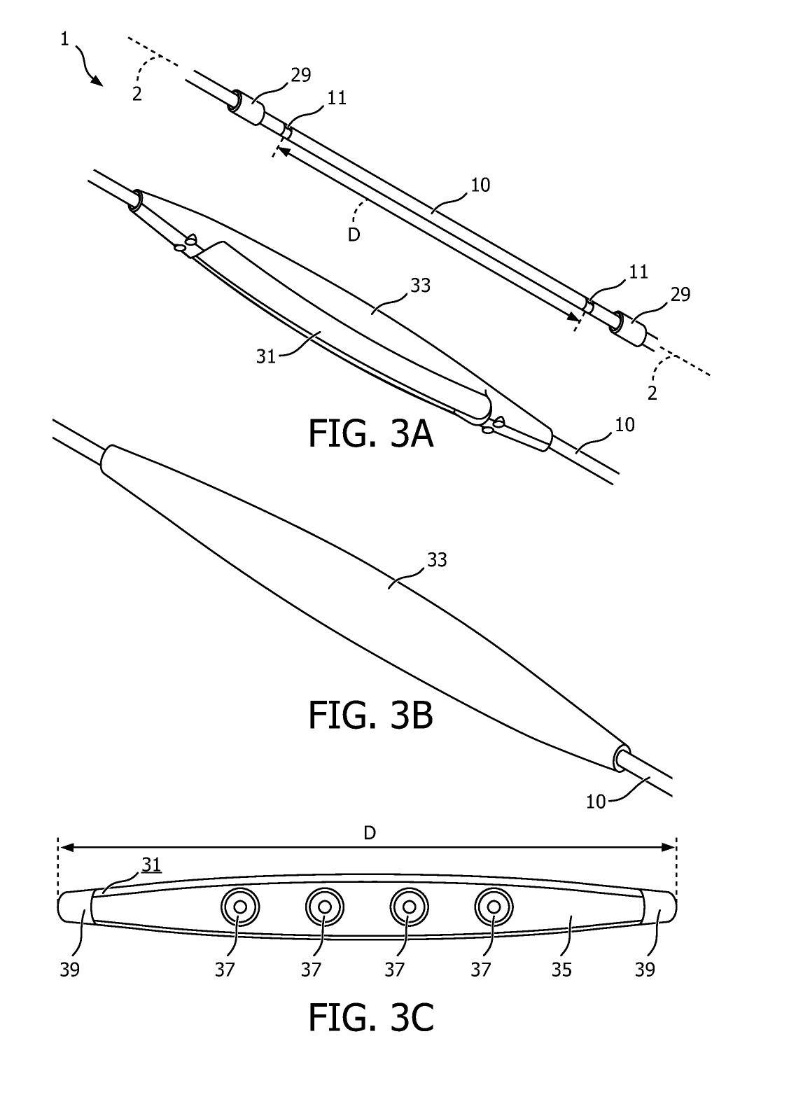

FIG. 3A shows a bottom view of a kit of parts 1 before and after a luminaire 31 is mounted on the kit of parts. The kit of parts comprises two contacting elements 11 mounted at a mutual distance D around the cable 10 that match with (the distance between) electrical connectors of the luminaire. On an outer side of each contacting element, viewed in length direction 2, a respective rubber ring 29 is provided to match with a housing 33 of the luminaire and to render the housing, accommodating the luminaire, watertight.

FIG. 3B shows a top view of the mounted luminaire of FIG. 3A. As is shown in the Figure, the housing 33 fits practically seamlessly around the cable 10 and has a relatively smooth outer surface. The luminaire with its housing, thus, is very suitable for outdoor applications as it is of a watertight construction and hardly susceptible to wind.

FIG. 3C shows a bottom view photograph of the luminaire 31 as accommodated in the housing as shown in FIGS. 3A and 3B. The luminaire has an elongated light emission window 35, which extends in the length direction of the cable. Through said window, light sources 37, in the Fig. LEDs, are visible. The luminaire further has two electrical connectors 39 arranged approximately at a mutual distance D for embracing corresponding contacting elements of the kit of parts.

1-12. (canceled)

13. A electrical component, comprising:
an insulated electric cable comprising at least two, mutually separated, electrically conducting wires embedded in an annular layer of electrically insulating material,
at least one electric contacting element comprising at least one piercing part, said piercing part penetrating the insulated electric cable and contacting at least one of the conducting wires,
wherein the at least one electric contacting element is made of pliant material and is wrapped around the cable, and
wherein the cable has an outer surface formed by the insulating material and that for each electrically conducting wire a respective wire location indication is provided at said outer surface at a position where the respective conducting wire is closest to the outer surface and in a length direction of the cable along the respective electrically conducting wire.

14. The electrical component of claim 13, wherein the conducting wires are eccentrically located in the cable.

15. The electrical component of claim 13, wherein the respective wire location indication is chosen from the group consisting of a relief in the outer surface, an imprint on the outer surface, local bulk-colored insulating covering material at the outer surface.

16. The electrical component of claim 13, wherein the contacting element has a form that has assumed the shape of the circumference of the cross section of the cable transverse to the length of the cable.

17. The electrical component of claim 13, wherein the contacting element is ring-shaped and wherein the at least one piercing part is mounted thereon such that it extends radially inwards.

18. The electrical component of claim 17, wherein the piercing part has a piercing length in the range of 1/18th to 5/18th of the circumference of the ring-shaped contacting element.

19. The electrical component of claim 13, wherein the piercing part comprises a fork-shaped extension with a V-shaped notch with mutually facing cutting knife edges for embracing the electrically conducting wire.

20. The electrical component of claim 13, wherein the cable comprises at least one longitudinal strength member extending along the electrically conducting wires.

21. A luminaire having electrical connectors, at least two of said electrical connectors having a shape matching with a respective contacting element of the electrical component of claim 13.
